(19) United States
(12) Patent Application Publication
(10) Pub. No.: US 2016/0267557 A1
(43) Pub. Date: Sep. 15, 2016

(54) Method and system for music collaboration crowd funding

(71) Applicant: Jens Peter Horvath, Holzkirchen (DE)

(72) Inventor: Jens Peter Horvath, Holzkirchen (DE)

(21) Appl. No.: 14/658,222

(22) Filed: Mar. 15, 2015

(51) Int. Cl. G06Q 30/02; G06Q 20/06; G06Q 50/00

(52) U.S. Cl. CPC G06Q 30/0279; G06Q 50/01; G06Q 20/06

(57) ABSTRACT

A system and method for funding the creation of audio tracks, comprising: provisioning of a expandable set to store prerecorded audio data in multiple tracks, request for funding indicator in the set, enabling a registered user to create the request for funding indicator providing the information about the expected funding amount in a permitted currency and a timeframe to reach this amount, allowing the requesting user to optionally provide a draft or sample of the track, allowing the requesting user optionally to add hypertext information as a description of the track to be funded, enabling the funding user to download or stream an arbitrary combination of tracks of the set including the sample of the track to be funded, enabling the funding user to provide an arbitrary amount of money in a given currency, a presentation of the remaining time and the remaining amount to reach the funding goal, the billing of the funding user and the refund in case the funding goal is not reached, the payment of the requesting user, enabling the requesting user to upload the funded track.

### BACKGROUND OF THE INVENTION

1. Field of the Invention

The present invention relates to funding of music data over a network, specifically to a system and method for a composition of music data over a network.

2. Description of the Related Art

In the related art, a variety of music collaboration systems and methods are used to collaborate on music compositions via a network. These music collaboration system enable the users to collaborate independently by providing audio tracks that compose the music composition. A variety of funding systems and methods are used to request a funding and enabling funding users to contribute to the funding goal. These funding systems are used by music bands to fund a song.

### SUMMARY OF THE INVENTION

The present invention has been developed in response to the present state of the art, and in particular, in response to the problems and needs in the art that have not yet been fully solved by currently available systems and methods for network collaboration on music data and funding single tracks of the music composition. Accordingly, the present invention has been developed to provide a system and method for a single user to raise a fund for providing a track to a combination of music tracks.

### DETAILED DESCRIPTION OF THE INVENTION

For the purposes of promoting an understanding of the principles of the invention, specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

An artist can create a new song project or contribute to an existing project. He can do this by uploading music tracks. When contributing to a project an artist can create a track that requests to fund the track. To illustrate the track the artist wants to provide to the project he can upload a sample of the track that might be a fraction of the track that will be provided when funding succeeds. He can describe the characteristics of the track.

An example could be a band that misses a talented guitar player. The band creates a project on the collaboration platform which could be cocompose e.g. The band uploads the single tracks of a song for that the guitar track is needed. They create an “artist wanted” entry in the community of the collaboration platform asking for a guitar player for their project. A talented guitar player creates now the funding request track in the project and provides a sample of his guitar track and the amount of money he is asking for and the time frame the funding should be open. The band can now provide the requested amount or the band can ask other users to participate in the funding. After funding succeeded the guitar player receives the requested amount of money and uploads the guitar track. If the funding does not succeed in the given timeframe the user that participated in the funding are refunded.
Users visiting the collaboration platform can browse projects and participate in the funding of the music tracks as long as the funding timeframe has not ended. They select the track and are asked by the system for the amount they want to provide. The amount is transferred to the platform by a payment system and treasured on the platform for the time the funding timeframe has not ended.

1. A system and method for funding the creation of audio tracks, comprising: a expandable set to store prerecorded audio data in multiple tracks, request for funding indicator in the set enabling the funding user to provide an arbitrary amount of money in a given currency, a presentation of the remaining time and the remaining amount to reach the funding goal, the billing of the funding user and the refund in case the funding goal is not reached, the payment of the requesting user.

2. The system of claim 1, further allowing the requesting user to optionally provide a draft or sample of the track.
